(19) United States
(12) Patent Application Publication
(10) Pub. No.: US 2005/0251453 A1
(43) Pub. Date: Nov. 10, 2005

(54) Online electronic media exchange system and method

(76) Inventor: Jun Lu, Missouri City, TX (US)

Correspondence Address: Delphine M. James;Attorney-at-Law, Ste. 170, 2656 South Loop West, Houston, TX, 77054, US

(21) Appl. No.: 10/838,922

(22) Filed: May 4, 2004

(51) Int. Cl. G06F 17/60

(52) U.S. Cl. 705/26

(57) ABSTRACT

The present invention provides a method and system of online trading of electronic media (i.e. CD's and DVD's containing movies and music. The method includes the steps of registering personal and rating information of an electronic media to be submitted for trading. A trading score is generated for the registered electronic media. A prioritized trading list is created based upon the trading score. The registered electronic media is then submitted into the pool for trading. From the trading list, an electronic media is selected to be exchanged for the submitted electronic media. Finally, the selected electronic media is delivered to the customer.

### BACKGROUND

The present invention relates to online trading systems. More particularly, the present invention relates to online trading systems for electronic media (i.e. DVD's, HD DVD's, Blu-Ray DVD, CD's, game cartridges and etc). Today consumers can buy and download electronic media online. In our economy, barter and exchange is common practice among our society. Currently, consumers buy movies and music stored on electronic media from some type of retail store. In order to trade the purchased electronic media, the consumer must find another consumer willing to trade. The present invention provides a public pooling system to facilitate consumer trading of music and movies stored on electronic media. As shown in FIG. 1, the traditional service oriented value chain starts with suppliers (i.e. distributors or wholesalers), the retail store adds value and sells to the consumers. The present invention creates a new business model as shown in FIG. 1A. As illustrated in FIG. 1A, the value chain becomes a value loop in which the consumers become their own suppliers. With the illustrated business model, the system continuously adds value by facilitating each trade of a submitted electronic media thereby creating the value loop.

### SUMMARY

The present invention provides a method and system of online trading of electronic media (i.e. CD's and DVD's containing movies and music. One of the main advantages of the system is that each registered member becomes a supplier for another registered member based upon the membership trading demand. The system allows the members to store for trading their electronic media in the service company's pooling facility. The company's pooling facility enhances the visibility and availability of the member's submitted electronic media. The system creates a new market place for members of electronic media.

The method includes the steps of registering personal and rating information of an electronic media to be submitted for trading. A trading score is generated for the registered electronic media. The trading score is based upon the demand of the submitted electronic media. The demand can be based upon the release date of the submitted media and the membership demand factors for the electronic media submitted into the pooling facility.

A prioritized trading list is created based upon the trading score. The registered electronic media is then submitted into the pool for trading. From the trading list, an electronic media is selected to be exchanged for the submitted electronic media. Finally, the selected electronic media is delivered to the customer.

The method of the present invention can be implemented utilizing various system components. The system components include a membership management component, rating mechanism component, pooling facility component, matching mechanism component, and delivery mechanism component. The membership management component manages the member's registration information and trading transaction information. The rating mechanism component creates a trading score for each member's submitted component. The pooling facility manages the available electronic media. Matching Mechanism manages the matching process between the member's desired electronic media on the priority list and the available electronic media. The delivery mechanism manages the delivery of the submitted electronic media.

### BRIEF DESCRIPTION OF DRAWINGS

FIG. 1 illustrates the traditional value added process.

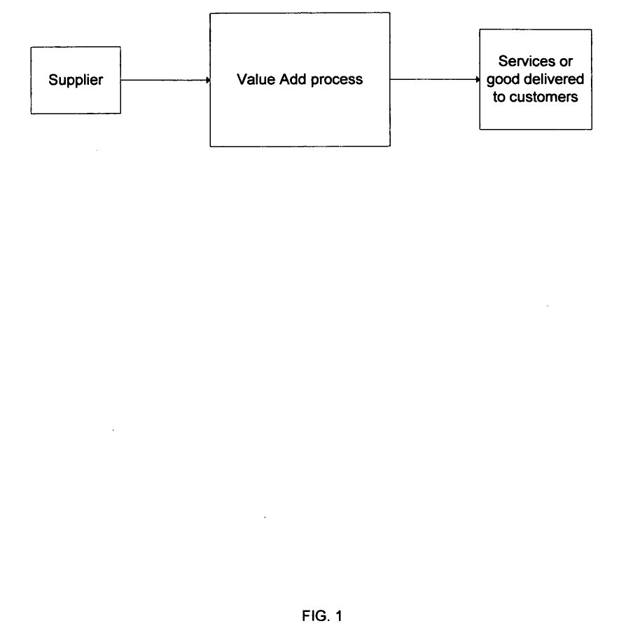

FIG. 1A illustrates the value added process of the present invention.

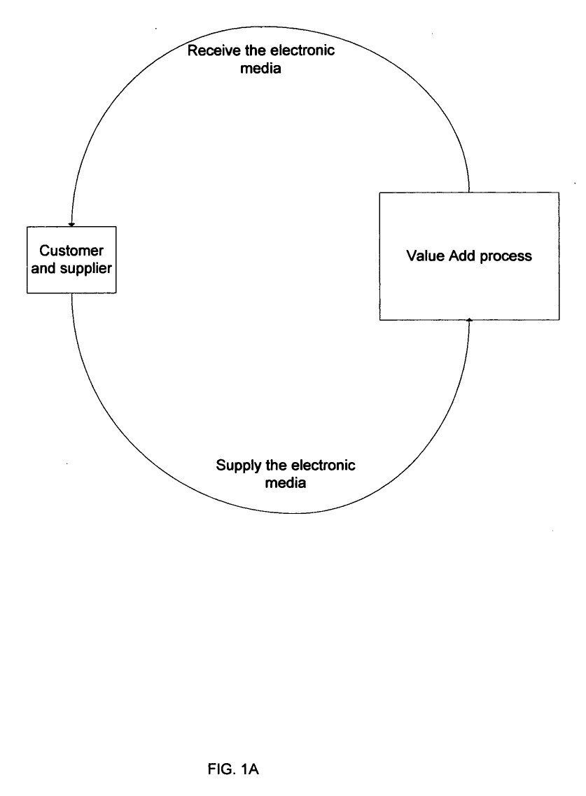

FIG. 2 illustrates the high level process of the system.

FIG. 2A is a block diagram of the system.

FIG. 3 illustrates a block diagram of the operational system architecture.

FIG. 4 illustrates a block diagram of a member's sign-up process.

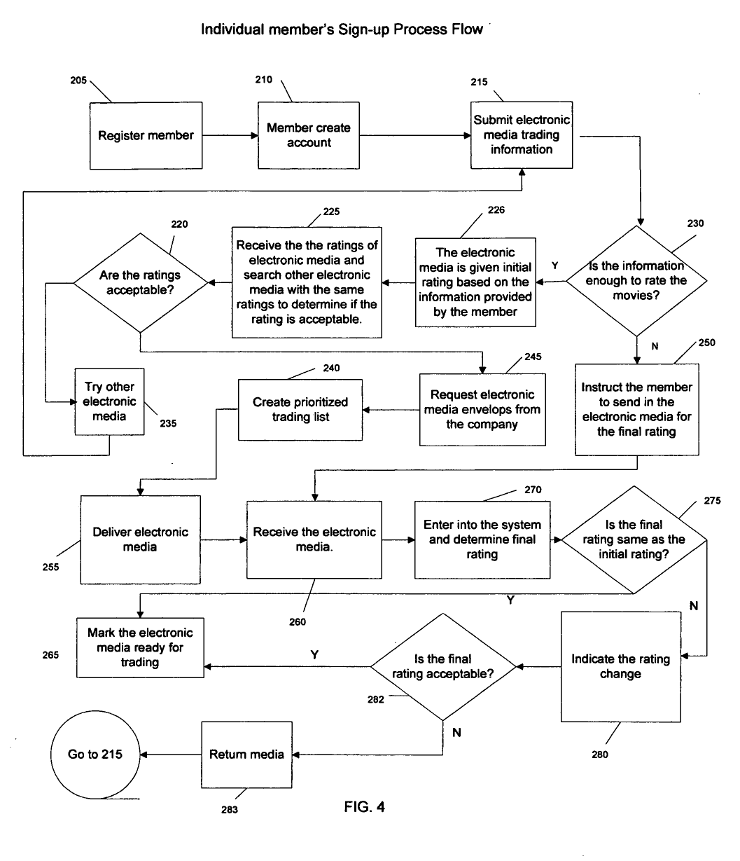

FIG. 5 illustrates a block diagram of a member's trading process.

### DETAILED SPECIFICATION

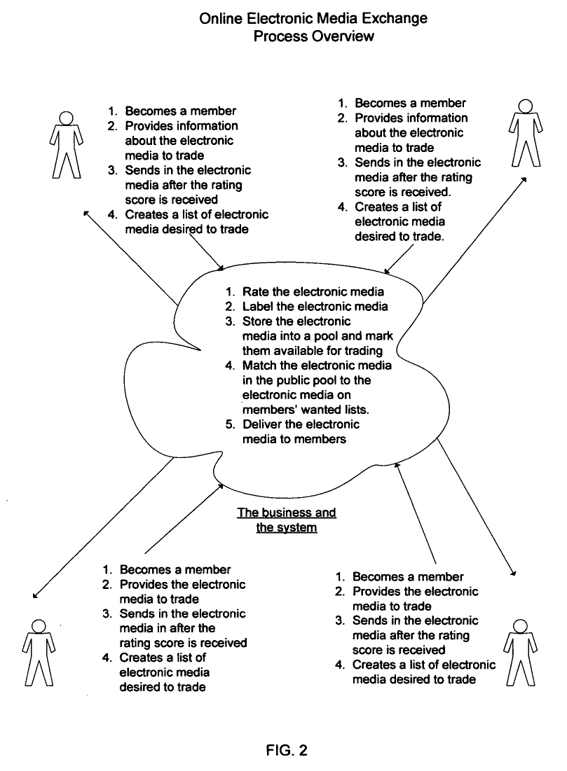

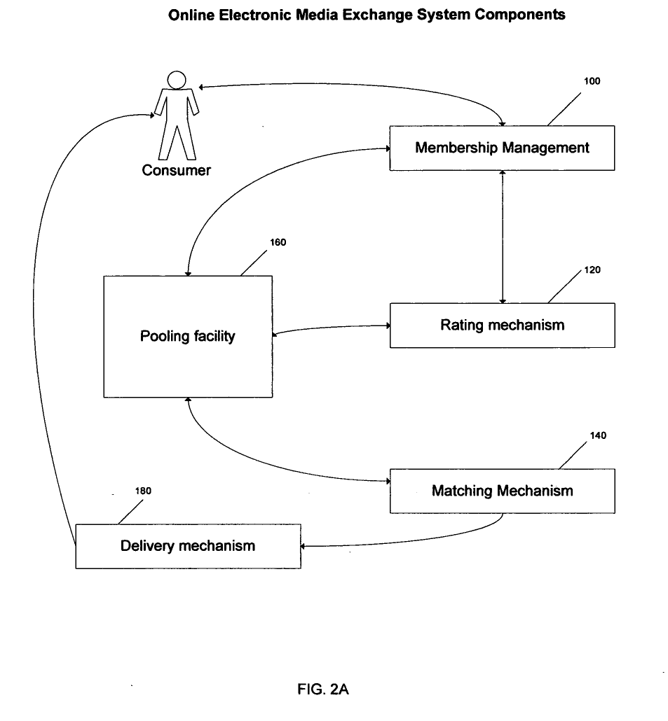

Referring to FIG. 2, there is shown a block diagram of the overall process implementing the online exchange system components illustrated in FIG. 2A. The Online Electronic Media Exchange system provides a virtual online club to allow its members to exchange (or trade) legally purchased media merchandise such as DVD'S, CD'S, game cartridges or any such type of electronic media merchandise.

The main components of the system are:
Membership Management (100) which interfaces with the consumer to register the electronic media and to submit the electronic for trading.
Rating Mechanism (120) which generates a trading score for the registered electronic media and creates a prioritized trading list for the consumer based upon the generated trading score and provides the list to Membership Management (100).
Pooling Facility (160) which manages the available electronic media merchandise to be exchanged. Each media is labeled and rated. Then, each media is physically and electronically stored.
Matching Mechanism (140) which interfaces with Pooling Facility (160) and selects from the trading list an electronic media to be exchanged for the submitted electronic media.
Delivery Mechanism (180) which manages the delivery of the selected media to the consumer.

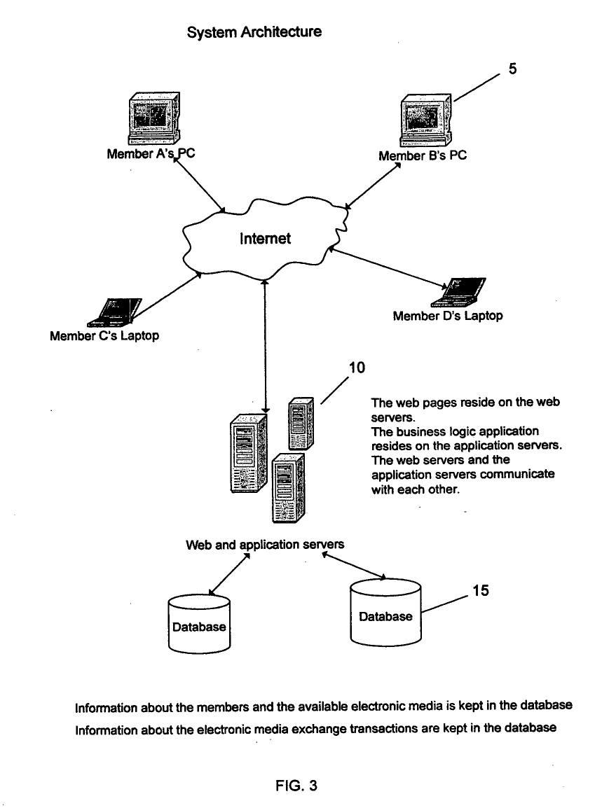

Referring to FIG. 3, there is shown a block diagram of the system hardware architecture to support the system. The system can be implemented in a client server environment utilizing on a computer network i.e. LAN, WAN or the Internet. A user utilizes a client machine such as a personal computing device (5). Personal computing device (5) can be a desk top, laptop, notebook, mobile phone or a suitable computing device to access the system executing on the web servers (10). Each personal computing device (5) can utilize conventional internet service provider software such as AOL, SBC or another provider to establish a connection to the system WEB server (10) utilizing conventional data communication protocols. The conventional communication protocol is generally TCP/IP. Additionally, proprietary client software can be developed to connect to Web Server (10) utilizing the conventional communication protocols.

The web server machine (10) provides the services over the network. In this case, the server machine (10) provides a web application for registering members and for providing members access to status the submission process of their electronic media. Additionally, there is a back office administration function of managing the pooling facility stored on a database management server system.

At least one web servers (10) house the website pages and the software required to support the system application which is described below. If multiple web servers are required, then web servers (10) can be networked together in a LAN or WAN. At least one database (15) is required to support the system. Databases (15) are required to store information on the members each electronic media exchange transaction, and each electronic media in the pool.

Referring to FIG. 3 there is shown a block diagram of the logical flow of how a member registers with the system. At step 205, a user accesses the system utilizing a conventional personal computing device through the Internet. The user provides some personal information and signs up for membership.

At step 210, the system creates a new account utilizing the provided personal information. The system can create a new account and store the account information in a conventional database system stored on the system network server.

At step 215, after the system creates the new account, the user is prompted to provide information regarding the electronic media that will be submitted for trading. At step 230, the system determines whether the provided information can be utilized to determine an initial rating. If an initial rating can be determined, the system proceeds to step 226 else the system proceeds to step 250.

At step 226, the system provides the initial rating to the user. At step 225, the member utilizes the provided initial trading score to search the available electronic media pool. Based upon the trading score, a subset of electronic media available for trading is provided to the user. At step 220, if the provided subset list is acceptable, the system proceeds to step 245. Otherwise, the system proceeds to step 235.

At step 235, the user has decided that the provided subset trading list is unacceptable. At that point, the system returns the user back to step 215 in which the user submits another electronic media for trading. The system allows the user to repetitively submit electronic media for trading until the user is provided an acceptable subset trading list.

At step 245, the user requests a mechanism for delivery of the electronic media to the company. The system delivers the provided mechanism to the user. The delivery mechanism can be mail envelops which can be utilized for Federal Express, US MAIL or UPS.

At step 240, the user creates a prioritized trading list based upon the subset trading list provided in step 220. Then, the user delivers the electronic media to the pool via the provided delivery mechanism at step 255. Then, the system proceeds to step 260.

The system proceeds to step 250 because the user could not provide rating information. Thus, at step 250, the system instructs the user to send the electronic media for the final trading rating. After receipt of the electronic media, the system proceeds to step 260.

At step 260, the system receives the sent electronic media. At step 270 the received electronic media is entered into the available trading pool. Then, a final trading score is determined by the system for the received electronic media. At step 275, if the final and the initial trading score are the same then, the submitted electronic media is marked ready for trading at step 265. However, if the final and the initial trading score are different, then the change is noted in the user's account. Additionally, the user can be notified by email of the change. The system proceeds back to step 282, which allows the user to determine if the final rating is acceptable. If the final trading rating is acceptable, then the system proceeds to step 265. However, if the final rating is not acceptable the media is returned to the user at step 283. For that user, the system proceeds to step 215 which allows the user to start the trading process over again.

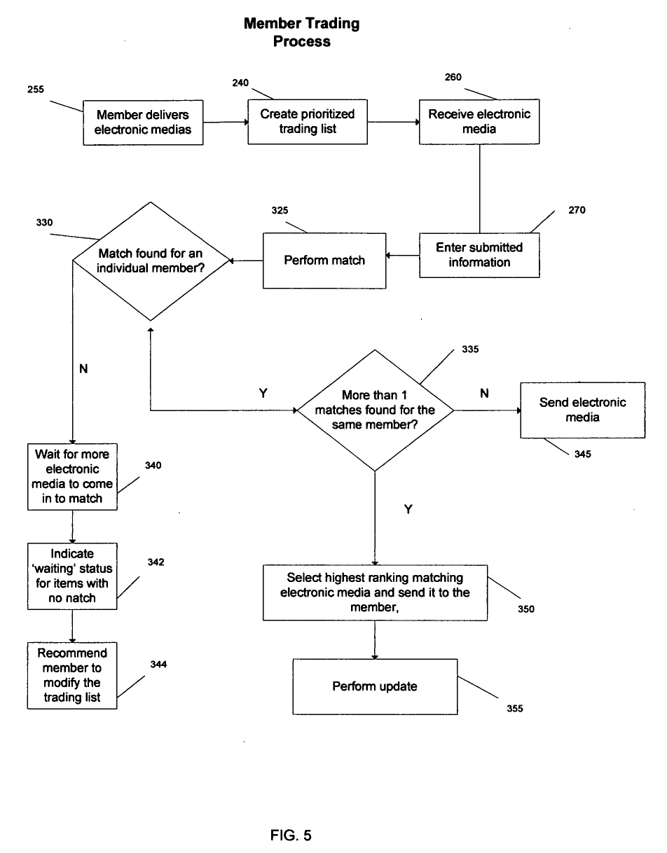

Referring to FIG. 5, there is shown a block diagram of member trading process. As discussed above, the user sends the electronic media to the pooling facility at step 255. After the electronic media is received by the system at step 260, the member's information is updated within the database system at step 270. The member can provide additional information in writing regarding the submitted electronic media. A final rating is also determined when the electronic media is received.

At step 325, a match is performed between the final prioritized list and the available electronic media in the pooling facility. At step 330, if a match is found the system proceeds to step 335 else the system proceeds to step 340. At step 335 if an exact match of one is found, the system proceeds to step 345 else the system proceeds to step 350.

At step 345 the physical electronic media is prepared for delivery to the member. The electronic media can be delivered by the US Postal Service, UPS, Federal Express, Courier Service or another suitable delivery means. Then, the database system is updated to reflect the change in ownership. When a user submits an electronic media for trading, the member relinquishes ownership to the system until an appropriate match can be made. Thus, when a match is made, the change in ownership to a new member must be reflected in the database system.

If the system proceeds to step 350, the highest ranking matched electronic media is sent to the member utilizing suitable delivery means. Then, at step 355, the database system is updated to reflect the change in ownership. When a user submits an electronic media for trading, the member relinquishes ownership to the system until an appropriate match can be made. Thus, upon the selection of the highest ranking electronic media, the change in ownership to the new member must be reflected in the database system.

If the system proceeds to step 340, no appropriate match was found for the member. The system is updated to reflect the fact that no match could be performed for this particular member. Thus, the system is updated to indicate a waiting status for this particular member. Then at step 344, the system recommends to the user to modify the member's prioritized trading list. The user is allowed to reenter step 240 and recreate a new trading list.

The algorithm to create the trading score for a submitted electronic media can be based upon the membership demand factor. The membership demand factor can be based upon the newness of the submitted electronic media and the demand factor for the electronic media. The newness factor is normally based upon the release date of an electronic media. A demand factor for a particular electronic media in the trading pool is created as each member creates their prioritized trading list. The system combines the newness factor and the demand factor to create one trading score for the submitted electronic media. Then, the submitted electronic media is placed into a particular category within the pooling facility based upon the calculated trading score.

The system creates a list of categories for the trading pool facility based upon the calculated trading scores for each electronic media in the trading pool. The number of categories, the demand factor algorithm, and the newness factor algorithm are variables within the system.

1. A method of online trading for electronic media from an available trading pool, the method comprising the steps of:
(a) registering an electronic media by a member for submission into the trading pool;
(b) generating a trading score for the registered electronic media;
(c) creating a prioritized trading list for the registered electronic media based upon the trading score;
(d) submitting the registered electronic media into the trading pool;
(e) selecting from the trading pool an electronic media on the trading list;
(f) updating the change in ownership for the selected electronic media and
(g) delivering to the at least one consumer the selected electronic media.

2. The method of claim 1 wherein the step of registering further comprises:
storing the member's rating information for the registered electronic media into a database system.

3. The method of claim 2 wherein the step of submitting further comprises updating the database system to indicate the change in ownership of the submitted electronic media.

4. The method of claim 2 wherein the selecting step further comprises updating the database system to indicate the change in ownership of the selected electronic media.

5. The method of claim 1 wherein the selecting step further comprises:
if no selection can be made, allow the member to repeat step (c);
if the prioritized trading list is unacceptable in step (c), allow the member to repeat steps (a-c);

6. The method of claim 1 wherein the selecting step further comprising:
accessing the trading pool; and
for each electronic media on the prioritized trading list, searching the trading pool until a match is found.

7. The method of claim 1 wherein the submitting step further comprises:
generating a final trading score;
if final trading score is different than the trading score, allowing the member to repeat steps (a-c).

8. The method of claim 1 further comprises segmenting the trading pool into various categories based upon the trading score;

9. The method of claim 8 wherein the creating step further comprises:
accessing the trading pool;
displaying to the member all the electronic media within the same category of the trading score; and
allowing the member to create the prioritized trading list from the displayed electronic media.

10. A system of online trading for electronic media from an available trading pool, the system comprising:
a membership management component operative to register an electronic media for a member, the registered media being submitted into the trading pool for exchange; a rating mechanism component operative to generate a trading score for the registered electronic media and to create a prioritized trading list for the registered electronic media;
a matching component operative to select from the trading pool an electronic media that matches an electronic media on the prioritized trading list;
a pooling facility management component operative to manage the exchange between the trading pool and the member; and
a delivery mechanism component operative to deliver the selected electronic media to the member.

11. The system of claim 10 wherein pooling facility management component is further operative to update the database system to indicate the change in ownership of the submitted electronic media.

12. The system of claim 11 wherein the pooling facility management component is further operative to update the database system to indicate the change in ownership of the matched electronic media.

13. The system of claim 10 wherein the matching component is further operative to:
if no match, allow the member to create a new prioritized trading list.

14. The system of claim 10 wherein the rating component is further operative to allow the member to register an alternative electronic media if the created prioritized trading list is unacceptable.

15. The system of claim 10 wherein the matching component is further operative to:
access the trading pool; and
for each electronic media in the prioritized trading list, search the trading pool until a match is found.

16. The system of claim 10 further comprises a submission component operative to:
receive the registered electronic media from the member;
generate a final trading score;
if final trading score is different than the trading score, allowing the member to register an alternative electronic media

17. The system of claim 10 wherein the pooling facility management component is further operative to segment the trading pool into various categories based upon the trading score.

18. The system of claim 17 wherein the rating component is further operative to:
access the trading pool;
display to the member all the electronic media within the same category of the trading score; and
allow the member to create the prioritized trading list from the displayed electronic media.

19. A computer readable medium having computer-executable instructions for performing a method of online trading for electronic media from an available trading pool, the method comprising the steps of:
(a) registering an electronic media by a member for submission into the trading pool;
(b) generating a trading score for the registered electronic media;
(c) creating a prioritized trading list for the registered electronic media based upon the trading score;
(d) submitting the registered electronic media into the trading pool;
(d) selecting from the trading pool an electronic media on the trading list;
(e) updating the change in ownership for the selected electronic media and
(f) delivering to the at least one consumer the selected electronic media.

20. A system implemented on a computer network for online trading of electronic media from an available trading pool, the system comprising:
a client machine and a server machine;
the client machine being programmed to access the server machine to:
(a) register an electronic media by a member for submission into the trading pool;
(b) generate a trading score for the registered electronic media;
(c) create a prioritized trading list for the registered electronic media based upon the trading score;
the server machine programmed to:
(d) accept the submitted the registered electronic media into the trading pool;
(e) select from the trading pool an electronic media on the trading list;
(f) update the change in ownership for the selected electronic media and
(g) deliver to the at least one consumer the selected electronic media.

21. The system of claim 1 wherein the server machine is further programmed to:
store the member's rating information for the registered electronic media into a database system.

22. The system of claim 2 wherein the server machine is further programmed to update the database system to indicate the change in ownership of the submitted electronic media.

23. The system of claim 2 wherein the server machine is further programmed to update the database system to indicate the change in ownership of the selected electronic media.

24. The system of claim 1 wherein the client machine is further programmed to:
if no selection can be made, allow the member to create an alternative prioritized trading list; and
if the prioritized trading list is unacceptable in (c), allow the member to repeat (a-c).

25. The system of claim 1 wherein the client machine is further programmed to:
access the trading pool; and
for each electronic media on the prioritized trading list, search the trading pool until a match is found.

26. The system of claim 1 wherein the server machine is further programmed to:
generate a final trading score;
if final trading score is different than the trading score, allow the member to repeat (a-c)

27. The system of claim 1 wherein the server machine is further programmed to segment the trading pool into various categories based upon the trading score.

28. The system of claim 8 wherein the client machine is further programmed to:
access the trading pool;
display to the member all the electronic media within the same category of the trading score; and
allow the member to create the prioritized trading list from the displayed electronic media.
